(19) United States
(12) Patent Application Publication
(10) Pub. No.: US 2023/0396591 A1
(43) Pub. Date: Dec. 7, 2023

(54) Server-Side Anonymous Identifier Web Service

(71) Applicant: Kinesso, LLC, New York, NY (US)

(72) Inventor: Andreas Schwibbe, Krummhoern (DE)

(21) Appl. No.: 18/034,316

(22) PCT Filed: Oct. 29, 2021
(86) PCT No.: PCT/US2021/057372

§ 371 Date: Apr. 27, 2023

Related U.S. Application Data
(60) Provisional application No. 63/107,700, filed on Oct. 30, 2020.

(51) Int. Cl. H04L 9/40

(52) U.S. Cl. CPC H04L 63/0421

(57) ABSTRACT

A callable web service stores relevant information either on an associations web server or on a third-party server on behalf of the association. The web service generates anonymous IDs. The browser on a user's electronic device calls the service by downloading digital properties prepared with a piece of code to initiate the call. The service responds by creating an anonymous ID. Software executing at the browser and the web service then begin a series of communications to establish methods of exchanging information between the two systems, and a payload with the anonymous ID is sent from the web service to the browser. In further communications, the anonymous ID acts as an anonymous browser reference as it passes between the web service and the browser.

### CROSS-REFERENCE TO RELATED APPLICATIONS

This application claims the benefit of U.S. provisional patent application No. 63/107,700, filed on Oct. 30, 2020. Such application is incorporated by reference herein.

### BACKGROUND

When servers maintained by a group or person conducting business on the World Wide Web (each, an “association” herein) interacts with browsers operating on electronic devices maintained by people accessing the Web (“users” herein), in particular via the associations' web pages maintained on their web servers, they want to identify these anonymous users for different purposes (messaging, account maintenance, service, etc.). For many years a common web technology, so-called “cookies,” has existed and enabled associations to “tag” their users by providing a digital identification (usually a generated alphanumeric string, an identifier or “ID”) and store this ID in the given user's browser storage local to the user's electronic device. When the user later directs his or her browser to the web server of the association again, the association can then read this ID through the user's browser in order to re-identify such users and thus are able to approach each user differently over time, such as with targeted messaging to the user.

A number of the providers of the most commonly used web browser software applications have announced an intent to cease technical support for cookies. The reason for this change is a concern over privacy that follows from using cookie information over time as a common practice to analyze user behavior without explicit consent. At present, however, these browser providers lack a technically equivalent replacement of the cookie feature. The loss of the browser cookie will leave associations without the ability to identify individual needs of users on their digital properties, which will result in, among other problems, users getting more irrelevant information from associations. This unguided communication will decrease the value for users to gather certain, wanted information as they need to put in more time to find useful information and separate unwanted information by themselves.

In order to preserve users' privacy and at the same time re-enable associations to separate their users in an easy way to tailor communications and adapt to different user's needs, what is needed is a computer-implemented method which acts as a full replacement for cookies, extends the capabilities of cookies, and guarantees user privacy by anonymity.

References mentioned in this background section are not admitted to be prior art with respect to the present invention.

### SUMMARY

In contrast to the client-side approach of existing browser cookie technology whereby a cookie is stored on the user's electronic device by the browser software, the present invention is directed to a server-side technology, whereby the relevant information is stored either on the association's web server or on a third-party server on behalf of the association. In certain implementations, the system may act as a callable web service. This web service generates anonymous identifiers, i.e., anonymous IDs. These anonymous IDs may be, for example, alphanumerics. The browser on the user's electronic device calls the service by downloading digital properties prepared with a piece of code to initiate the call. The service responds by creating the anonymous ID. Software executing at the browser and the web service then begin a series of communications to establish, for example, methods of exchanging information between the two systems, and a payload with the anonymous ID is sent from the web service to the browser. In further communications, the anonymous ID acts as an anonymous browser reference as it passes between the web service and the browser.

Because the anonymous ID is generated by the web service in a random fashion and thus cannot contain any private information, it cannot be reversed or otherwise processed in order to learn the identity of a user associated with the browser to which it pertains. The service in certain implementations maintains a log, such as one associating timestamps of calls and anonymous IDs, to provide information about the number of different browsers that have communicated through a particular digital property in a time period. The database may further associate a particular digital message sent to the browser with the timestamp and anonymous identifier by using a message identifier, i.e., a creative ID.

These and other features, objects and advantages of the present invention will become better understood from a consideration of the following detailed description of the preferred embodiments and appended claims in conjunction with the drawings as described following:

### DRAWINGS

FIG. 1 is a swim lane chart depicting a communication process between a web service and a user browser according to an implementation of the present invention.

FIG. 2 is a functional system diagram according to an implementation of the present invention.

FIG. 3 is a structural system diagram according to an implementation of the present invention.

### DETAILED DESCRIPTION OF THE PREFERRED EMBODIMENT(S)

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

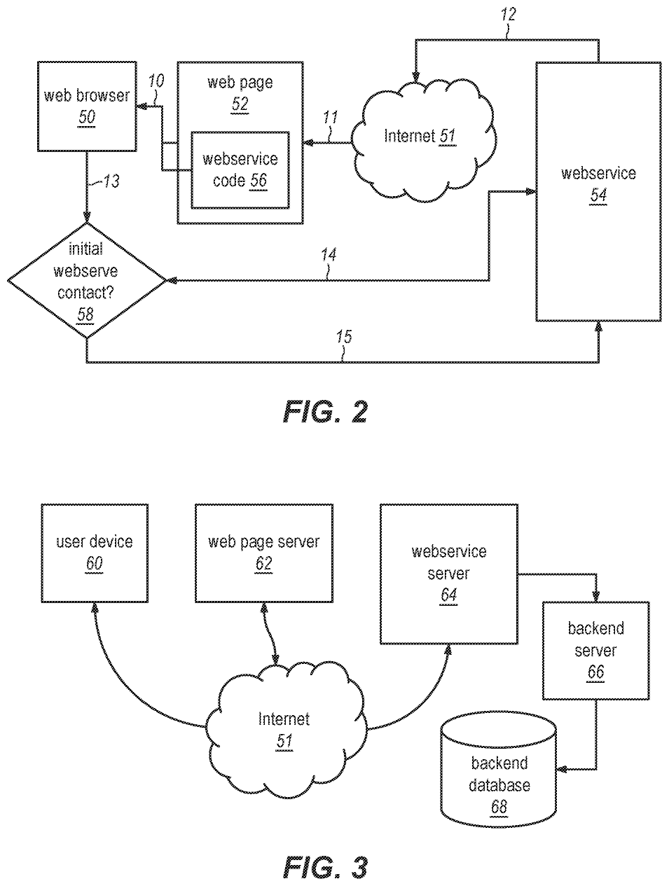

As shown in FIGS. 2 and 3, a system according to an implementation of the invention may involve an electronic device 60 executing a web browser 50 directed by a user; an association web server 62 that provides a web site or page 52 accessible by the user's electronic device 60 web browser 50; and a web service server 64 hosting a third-party web service 54 that is callable by the browser 50 executing at the user's electronic device 60. Each of these systems communicate over a network 51, such as the Internet. The web service 54 generates anonymous identifiers, i.e., anonymous IDs. The anonymous IDs may be created, for example, by a routine whose only input is a random number generator, such as is found on computers or software that randomizes a number by turning existing computer events (hidden processor states, sequences of network packets, state of memory translation tables, etc.) into a random number or alphanumeric output. The anonymous ID is generated in certain implementations with a sufficient length and variety in order to effectively prevent collisions (i.e., the result that two randomly generated strings are identical) for the expected number of users. In one example, the anonymous ID may be a 128-bit number.

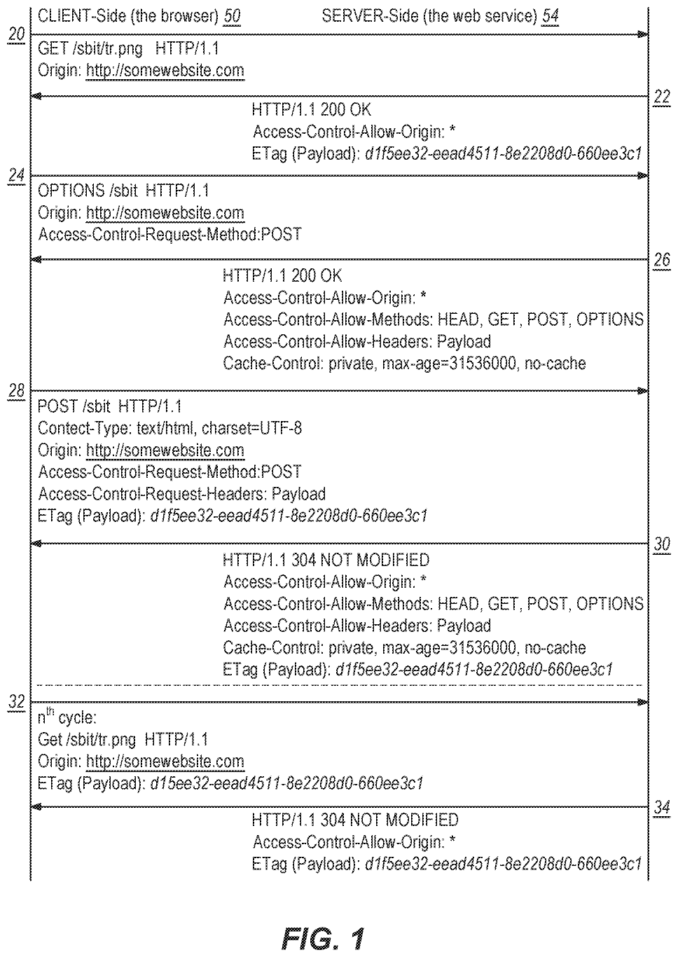

A process performed by this system may be illustrated by the example of FIG. 1. At first call 20, the web service 54 is called from the browser 50 executing at the user's electronic device 60 by downloading digital properties (e.g., a web page or a digital message 52) prepared with a piece of code 56 (such as a JavaScript code snippet) that initiates the call of this service 54 from the browser on behalf of the association. In this first call 20 the browser 50 submits the origin (such as the URL) from which the call is performed to the web service 54. In this case, the URL is http://somewebsite.com. This call initiates a first-call response 22 from the web service 54, with a randomly generated anonymous ID in a W3C-conforming protocol answer so that the browser 50 understands it. Furthermore, this response permits further communication to this web service 54 from the given origin (the “1st response”). The “payload” or “ETag” in this case is the anonymous ID d1f5ee32-eead4511-8e2208d0-660ee3c1.

According to the W3C protocol standards the browser 50 will then probe the web service 54 to understand which methods for exchanging data between the user electronic device's browser (client side) 50 and the web service (server side) 54 it supports, shown in FIG. 1 as second call 24. The web service 54 will reply to this second request with a second-call response 26 that contains all of the methods it supports and instructs the browser to use one of the supported methods.

According to the protocol standards, the browser 50 will reply to the last web service 54 response with its own response as third-call 28, by using one of the previously offered methods and also submits the previously assigned anonymous ID as a payload to establish the client server communication. The server operating web service 54 will finally respond with third-call response 30, which is a summary confirming these settings as the agreed connection settings for all further communication, which includes the anonymous ID as a payload and also a maximum age at which the web service 54 will consider these settings as valid. The web browser (e.g., Chrome, Edge, or Firefox) 50 then will use its own proprietary methods to process and further access this information at further call 32, which could possibly include local storage of this information or parts of this information on the user electronic device 60. Further responses from web service 54 are illustrated in FIG. 1 as further call response 34.

Any further download of prepared digital properties of a given association will trigger a new first call 20 to the web service 54 from the browser 50 executing on the user's electronic device 60. This may occur, for example, if the user directs the browser 50 on his or her electronic device 60 to the same web site or subsequent call at decision block 58 of FIG. 2. As the user's browser 50 might already be aware of the connection settings, it might have already negotiated with the web service 54 upon the very first contact; in that case, it does not need to establish a new connection as long as the time period given by the web service 54 in the initial third-call response 30 is not due yet. Even if the connection is no longer established, it can be re-established with a direct further call 32 by the user's browser 50 with the known and valid settings, as they are known to both the user's browser 50 and the web service 54 and are still valid. In this case the web service 54 will respond with a special response version 34 of first-call response 22, informing the browser 50 that nothing has changed and that the settings are still valid.

The anonymous ID now acts as an anonymous browser reference as it passes between both parties back and forth for the period that has been assigned as valid. As the anonymous ID acting as a reference to a certain web browser 50 is provably generated only by randomness on the server-side (i.e., web service 54) exclusively, it may be defined as a universally unique identifier version 4 or UUID4( ) data type acting as an anonymous identifier. An anonymous ID of this sort grants the highest kind of privacy to individuals, because no individual feature is part of the ID or the generation process, and thus cannot be reversed or guessed.

The web service 54 in certain implementations will further log any calls in a time series in database 68 on a backend server 66 containing a timestamp and the anonymous ID, such as shown by example in Table 1:

TABLE 1

| Timestamp | Anonymous ID |
|---|---|
| 1592577368 | d1f5ee32-eead4511-8e2208d0-660ee3c1 |
| 1592578439 | d1f5ee32-eead4511-8e2208d0-660ee3c1 |
| 1592578499 | d1f5ee32-eead4511-8e2208d0-660ee3c1 |
| . . . | |

This database 68 allows the association to have a basic understanding of how many different user browsers 50 visited their digital properties 52 in a given time period.

The web service 54 in this implementation described herein is adaptable to accept further metadata exchanged in the established or re-established connection. This could be information such as but not limited to which part of a web page 52 has been visited, which creative of a digital message has been viewed, which product has been purchased, etc. The association can pass this metadata into the connection by modifying the code used to prepare their digital properties to trigger the client-side call (i.e., the “first call” 20) from a user's browser 50 to this web service 54. Thus, the database 68 table could possibly be enhanced from that shown in Table 1 as shown in Table 2:

TABLE 2

| Timestamp | Anonymous ID | Creative ID |
|---|---|---|
| 1592577368 | d1f5ee32-eead4511- | 214dcabf62aa42d7 |
| | 8e2208d0-660ee3c1 | |
| 1592578439 | d1f5ee32-eead4511- | cf76a8f6ec16b134 |
| | 8e2208d0-660ee3c1 | |
| 1592578439 | d1f5ee32-eead4511- | f7b0ce1232ff7812 |
| | 8e2208d0-660ee3c1 | |
| . . . | | |

This approach then extends the basic information of the database by adding which specific element of a digital message campaign has been viewed and when it was viewed by which browser 50, as each browser 50 is associated with a particular anonymous ID.

The web service 54 may individually be extended by any given association with its own proprietary metadata and accepts data in common secure hashed formats only. The accepted hashed metadata is then hashed once more by the web service 50 itself with an anonymous ID individual hash-salt to guarantee each user's privacy. Without knowing the association's hash algorithm, the metadata is not readable by the web service 54 (if operated by a third party on behalf of the association) or any other third party. However, for the association itself the metadata is still reversible as it knows its own hash algorithm and thus metadata is only pseudonymous in this context. In this case an association would be able to dilute a user's privacy and anonymity by de-anonymizing the anonymous ID by adding personal identifiable information (“PII”) as metadata, as in the following example:
Anonymous ID: d1f5ee32-eead4511-8e2208d0-660ee3c1
Timestamp: 1592578439
meta-data: John Doe
   By adding a personal identifiable information such as “John Doe” as metadata to the anonymous ID, the anonymous ID would become personally identifiable information (PII) itself as it can be linked to a PII data set. Even if the association is using a secure hash function for the metadata such as hash(“John Doe”+1234)=>967b189789f01471865df4f683b2e84e1fed5e4b, it is still possible for the association to reverse the data as the secure hash function that was used and the hash salt is known to the association. The database records in the backend database 68 of this web service 54 would still be anonymous to everyone but the association.

To maintain anonymity, the submitted association metadata is hashed once more by the web service 54 with both its own hash function and a hash salt specific to an anonymous ID not known to the association. Logic for this approach may be as follows:
where 1234 is the association hash-salt only known to the association,
ABCD is the web service's hash salt (of any length) known only to the web service 54, but specific to an anonymous ID,
hash_{w} is the hash function used by the web service 54,
hashₐ is the hash function used by the association, then:
hash_{w}(“hashₐ(“John Doe”+1234)”+ABCD″)=>
hash_{w}(“967b189789f01471865df4f683b2e84e1fed5e4b”+ABCD″)=>
15b86c26a1d91df58f4fdd3969d877020e97509d
   A variety of hash functions may be used to generate hash_{w} from hashₐ, with logic as follows:
hashₐ(“John Doe”+1234)
=>967b189789f01471865df4f683b2e84e1fed5e4b
=>submit as association hashed metadata to web service 54
=>web service checks and accepts, then applies its own hash function
=>hash_{w}(“967b189789f01471865df4f683b2e84e1fed5e4b”+ABCD)
=>15b86c26a1d91df58f4fdd3969d877020e97509d
=>submit to web service 54 backend database 68
   This process guarantees anonymity to the user as well as to all other parties involved. Thus, this computer implemented method is increasing the privacy of users compared to previously used cookies and still enables associations to analyze, target and segment (i.e., divide into groups based on messaging categories) various users. The versatility to accept metadata extends the limited-capability cookies originally offered by browsers 50 and, because of all its properties, it may not be impacted by various privacy laws, regulations, and rules, including without limitation the General Data Protection Regulation (GDPR) applicable in the European Union.

In certain implementations, the data format for the various data structures described herein may be as follows. The web service 54 generates an anonymous ID with at least 128-bit randomness to prevent collisions (or at least to make them extremely unlikely) and act as an anonymous browser reference. In the following example, it should be noted that the anonymous ID retention period may be subject to variations in the software implementing the browser 50 on the user's electronic device 60, and also may be limited to the maximum due date set by the association, and also may be impacted by consent management platform instructions that may be driven by applicable privacy laws, regulations, and rules:
Example: d1f5ee32-eead4511-8e2208d0-660ee3c1
Retention period: subject to proprietary browser methods AND, OR
   subject to webservice's max-due date AND, OR
   subject to consent management platform instructions
Data type: UUID4( )
Data set: mandatory IF
   no-consent given, data set will be nulled:
   00000000-00000000-00000000-00000000
      The web service 54 logs its IDs in a time series of events in a backend database 68 with an epoch, i.e., an instant in time chosen as the origin of a particular date and time:
Example: 1592577368
Retention period: none
Data type: timestamp
Data set: mandatory
This web service optionally logs metadata in hashed format:
Example: 214dcabf62aa42d7
Retention period: none
Data type: double hashed with at least one salt
Data set: optional

As illustrated by the swim lane process flow diagram of FIG. 1, the system acts as a custom build threaded web server, which complies with common W3C standards and uses a client-side executed JavaScript XHR snippet to collect related metadata information with the help of a common web technique called Cross-Origin Resource Sharing (CORS). The web service 54 responds to client-side requests with server-side answers and a payload that does not imply any client data but is instead random (the anonymous ID). It thus changes hypertext transfer protocol (http) status codes within the client- and server-side communication in a non-regular but still compliant way to achieve its goal of a CORS for server-side generated anonymous IDs. Therefore, the web service 54 is a global accessible remote service with a client-side executed code snippet such as a JavaScript snippet initiating the CORS, which is implemented in the digital properties of the one or more associations. When content is served on any website 52 containing prepared digital properties of the associations then the JavaScript snippet (webservice code 56) gets served too, initiating an uncommon but conform CORS request for a regular image pixel. The server responds to this request with a regular but specific answer and a server-generated payload. This payload is the anonymous ID as described earlier. As soon as the response answers the initial request, an OPTIONS request is probed to this web service, verifying the accepted methods for the JavaScript code snippet to use the payload to play it back in a third request. Metadata may be optionally added to this request. This web service 54 accepts this request with a non-conforming (but still compliant) http status code and saves the payload in the backend database 68 together with a timestamp. This prepares and instructs the browser 50 for another loop and to re-use the original settings from the very first call.

The invention is not limited to the specific implementation as described above. In a more general (but nevertheless not exclusive) example, when web browser 50 is directed by a user to open a web page 52 on the World Wide Web, the web browser 50 of this user downloads both the web page 52 and a web service code 56 simultaneously. The web page 52 has been prepared with the web service code 56 prior to the access by the owner of the web page 52. While the web page 52 is displayed in the user's web browser 50, the web service code 56 initiates a separate request to this web service 54 via the Internet 51 to prepare a direct connection 13 between the web browser 50 and the web service 54.

If this is the first-ever connection between web browser 50 and web service 54, then the initial three-way handshake (the three calls and three responses as described above) are initiated at communication path 14 to establish valid connection settings for future connections. For any further communications between this web browser 50 and this web service 54, the connection settings agreed in the initial communication 14 can be reused at path 15.

Connection path 15 can further be used to transfer metadata from the web web service code 56 is dynamically adjusted by the web page 52 between two different page loads and thus two separate communication path sets 15. This web browser 50 will transport metadata from web page 52 over communication path 15 to this web service 54 without modifying it using a secured transport layer. All of the communication paths 10 (web page 52 to browser 50), 11 (Internet 51 to Web service code 56); 12 (web service 54 to the Internet 51); 13 (web browser 50 to decision block 58), 14 (“yes” response to first-time communication), and 15 (“no” response to first-time communication) use end-to-end encryption.

In the implementations described herein and in various alternative implementations, the present invention may be implemented by any combination of hardware and software. For example, in one embodiment, the systems and methods may be implemented by a computer system or a collection of computer systems, each of which includes one or more processors executing program instructions stored on a computer-readable storage medium coupled to the processors. The program instructions may implement the functionality described herein. The various systems and displays as illustrated in the figures and described herein represent example implementations. The order of any method may be changed, and various elements may be added, modified, or omitted.

A computing system or computing device as described herein may implement a hardware portion of a cloud computing system or non-cloud computing system, as forming parts of the various implementations of the present invention. The computer system may be any of various types of devices, including, but not limited to, a commodity server, personal computer system, desktop computer, laptop or notebook computer, mainframe computer system, handheld computer, workstation, network computer, a consumer device, application server, storage device, telephone, mobile telephone, or in general any type of computing node, compute node, compute device, and/or computing device. The computing system includes one or more processors (any of which may include multiple processing cores, which may be single or multi-threaded) coupled to a system memory via an input/output (I/O) interface. The computer system further may include a network interface coupled to the I/O interface.

In various embodiments, the computer system may be a single processor system including one processor, or a multiprocessor system including multiple processors. The processors may be any suitable processors capable of executing computing instructions. For example, in various embodiments, they may be general-purpose or embedded processors implementing any of a variety of instruction set architectures. In multiprocessor systems, each of the processors may commonly, but not necessarily, implement the same instruction set. The computer system also includes one or more network communication devices (e.g., a network interface) for communicating with other systems and/or components over a communications network, such as a local area network, wide area network, or the Internet. For example, a client application executing on the computing device may use a network interface to communicate with a server application executing on a single server or on a cluster of servers that implement one or more of the components of the systems described herein in a cloud computing or non-cloud computing environment as implemented in various sub-systems. In another example, an instance of a server application executing on a computer system may use a network interface to communicate with other instances of an application that may be implemented on other computer systems.

The computing device also includes one or more persistent storage devices and/or one or more I/O devices. In various embodiments, the persistent storage devices may correspond to disk drives, tape drives, solid state memory, other mass storage devices, or any other persistent storage devices. The computer system (or a distributed application or operating system operating thereon) may store instructions and/or data in persistent storage devices, as desired, and may retrieve the stored instruction and/or data as needed. For example, in some embodiments, the computer system may implement one or more nodes of a control plane or control system, and persistent storage may include the SSDs attached to that server node. Multiple computer systems may share the same persistent storage devices or may share a pool of persistent storage devices, with the devices in the pool representing the same or different storage technologies.

The computer system includes one or more system memories that may store code/instructions and data accessible by the processor(s). The system memories may include multiple levels of memory and memory caches in a system designed to swap information in memories based on access speed, for example. The interleaving and swapping may extend to persistent storage in a virtual memory implementation. The technologies used to implement the memories may include, by way of example, static random-access memory (RAM), dynamic RAM, read-only memory (ROM), non-volatile memory, or flash-type memory. As with persistent storage, multiple computer systems may share the same system memories or may share a pool of system memories. System memory or memories may contain program instructions that are executable by the processor(s) to implement the routines described herein. In various embodiments, program instructions may be encoded in binary, Assembly language, any interpreted language such as Java, compiled languages such as C/C++, or in any combination thereof; the particular languages given here are only examples. In some embodiments, program instructions may implement multiple separate clients, server nodes, and/or other components.

In some implementations, program instructions may include instructions executable to implement an operating system (not shown), which may be any of various operating systems, such as UNIX, LINUX, Solaris™, MacOS™, or Microsoft Windows™. Any or all of program instructions may be provided as a computer program product, or software, that may include a non-transitory computer-readable storage medium having stored thereon instructions, which may be used to program a computer system (or other electronic devices) to perform a process according to various implementations. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to the computer system via the I/O interface. A non-transitory computer-readable storage medium may also include any volatile or non-volatile media such as RAM or ROM that may be included in some embodiments of the computer system as system memory or another type of memory. In other implementations, program instructions may be communicated using optical, acoustical or other form of propagated signal (e.g., carrier waves, infrared signals, digital signals, etc.) conveyed via a communication medium such as a network and/or a wired or wireless link, such as may be implemented via a network interface. A network interface may be used to interface with other devices, which may include other computer systems or any type of external electronic device. In general, system memory, persistent storage, and/or remote storage accessible on other devices through a network may store data blocks, replicas of data blocks, metadata associated with data blocks and/or their state, database configuration information, and/or any other information usable in implementing the routines described herein.

In certain implementations, the I/O interface may coordinate I/O traffic between processors, system memory, and any peripheral devices in the system, including through a network interface or other peripheral interfaces. In some embodiments, the I/O interface may perform any necessary protocol, timing or other data transformations to convert data signals from one component (e.g., system memory) into a format suitable for use by another component (e.g., processors). In some embodiments, the I/O interface may include support for devices attached through various types of peripheral buses, such as a variant of the Peripheral Component Interconnect (PCI) bus standard or the Universal Serial Bus (USB) standard, for example. Also, in some embodiments, some or all of the functionality of the I/O interface, such as an interface to system memory, may be incorporated directly into the processor(s).

A network interface may allow data to be exchanged between a computer system and other devices attached to a network, such as other computer systems (which may implement one or more storage system server nodes, primary nodes, read-only node nodes, and/or clients of the database systems described herein), for example. In addition, the I/O interface may allow communication between the computer system and various I/O devices and/or remote storage. Input/output devices may, in some embodiments, include one or more display terminals, keyboards, keypads, touchpads, scanning devices, voice or optical recognition devices, or any other devices suitable for entering or retrieving data by one or more computer systems. These may connect directly to a particular computer system or generally connect to multiple computer systems in a cloud computing environment, grid computing environment, or other system involving multiple computer systems. Multiple input/output devices may be present in communication with the computer system or may be distributed on various nodes of a distributed system that includes the computer system. The user interfaces described herein may be visible to a user using various types of display screens, which may include CRT displays, LCD displays, LED displays, and other display technologies. In some implementations, the inputs may be received through the displays using touchscreen technologies, and in other implementations the inputs may be received through a keyboard, mouse, touchpad, or other input technologies, or any combination of these technologies.

In some embodiments, similar input/output devices may be separate from the computer system and may interact with one or more nodes of a distributed system that includes the computer system through a wired or wireless connection, such as over a network interface. The network interface may commonly support one or more wireless networking protocols (e.g., Wi-Fi/IEEE 802.11, or another wireless networking standard). The network interface may support communication via any suitable wired or wireless general data networks, such as other types of Ethernet networks, for example. Additionally, the network interface may support communication via telecommunications/telephony networks such as analog voice networks or digital fiber communications networks, via storage area networks such as Fibre Channel SANs, or via any other suitable type of network and/or protocol.

Any of the distributed system embodiments described herein, or any of their components, may be implemented as one or more network-based services in the cloud computing environment. For example, a read-write node and/or read-only nodes within the database tier of a database system may present database services and/or other types of data storage services that employ the distributed storage systems described herein to clients as network-based services. In some embodiments, a network-based service may be implemented by a software and/or hardware system designed to support interoperable machine-to-machine interaction over a network. A web service may have an interface described in a machine-processable format, such as the Web Services Description Language (WSDL). Other systems may interact with the network-based service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP). In some embodiments, network-based services may be implemented using Representational State Transfer (REST) techniques rather than message-based techniques. For example, a network-based service implemented according to a REST technique may be invoked through parameters included within an HTTP method such as PUT, GET, or DELETE.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. When a grouping is used herein, all individual members of the group and all combinations and subcombinations possible of the group are intended to be individually included. When a range is stated herein, the range is intended to include all subranges and individual points within the range. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A method for anonymously referencing a user web browser hosted at a user electronic device, comprising the steps of:
loading a web service code onto a web page server, wherein the web service code is accessible by the user web browser when the user web browser accesses a web page hosted by the web page server;
when the web service code is accessed by the user web browser, initiating a web service request at a web service hosted at a web server browser to prepare a connection between the user web browser and the web service; and
generating an anonymous identifier at the web service;
sending at least one initial handshake call response from the web service to the user web browser, wherein the at least one initial handshake call response comprises the anonymous identifier.

2. The method of claim 1, wherein the step of generating the anonymous identifier is performed using a random number generator.

3. The method of claim 2, wherein the random number comprises a size of at least 128 bits.

4. The method of claim 1, wherein the at least one initial handshake call response comprises a first call response from the web service, wherein the first call response comprises the anonymous identifier.

5. The method of claim 4, wherein the at least one initial handshake call response further comprises a second call response from the web service to the user web browser, wherein the second call response comprises at least one permitted data exchange method and instructions to the user web browser to use one of the at least one permitted data exchange methods.

6. The method of claim 5, wherein the at least one initial handshake call response further comprises a third call response from the web service to the user web browser, wherein the third call response comprises a setting confirmation, the anonymous identifier, and a maximum age.

7. The method of claim 6, further comprising the step of sending at least one initial call from the user web browser to the web service prior to sending the at least one initial call response from the web service to the user web browser.

8. The method of claim 7, wherein the at least one initial call comprises a first initial handshake call comprising an origin from which the first initial handshake call is performed.

9. The method of claim 8, wherein the at least one initial handshake call further comprises a second initial call from the user web browser to the web service comprising a probe to understand permitted data exchange methods between the user web browser and the web service.

10. The method of claim 9, wherein the at least one initial handshake call further comprises a third initial call from the user web browser to the web service comprising a confirmation of a one of the permitted data exchange methods and the anonymous identifier.

11. The method of claim 10, further comprising the step of storing the at least one permitted data exchange method and the anonymous identifier at the user electronic device.

12. The method of claim 6, further comprising the step of sending a subsequent response from the web service to the user web browser, wherein the subsequent response is sent after the step of sending a third call response from the web service to the user web browser, and wherein the subsequent response comprises the anonymous identifier as a reference.

13. The method of claim 12, further comprising the step of receiving a subsequent call from the user web browser at the web service, wherein the subsequent call comprises the anonymous identifier.

14. The method of claim 13, further comprising the step of logging each subsequent call at a backend server database, wherein each of a plurality of entries in the backend server database comprise a timestamp and the anonymous identifier associated with the user web browser.

15. The method of claim 14, wherein each of the plurality of entries in the backend server database further comprise a creative identifier, wherein the creative identifier is uniquely associated with a particular message delivered from the web page at the web server to the user web browser.

16. The method of claim 15, further comprising the step of associating metadata with the anonymous ID, further comprising the step of applying a first hash function to the metadata to produce hashed metadata.

17. The method of claim 16, further comprising the step of applying a second hash function to the hashed metadata and the anonymous identifier to produce second hashed metadata.

18. The method of claim 1, wherein the web service code comprises a code snippet.

19. A user anonymous reference system, comprising:
a web service server, wherein the web service server hosts a web service configured to generate an anonymous identifier and send at least one initial handshake call response to a user web browser wherein the at least one initial handshake call response comprises the anonymous identifier;
a web page server, wherein the web page server hosts a web page and a web service code, wherein the web service code is accessible by a user web browser hosted at a user device when the user web browser accesses the web page hosted by the web page server, and wherein the web page server is configured to, when the web service code is accessed by the user web browser, initiate a web service request at the web service to prepare a connection between the user web browser and the web service.

20. The user anonymous reference system of claim 19, wherein the web service is configured to generate a first call response to the user browser comprising the anonymous identifier, a second call response to the user browser comprising at least one permitted data exchange method, and a third call response to the user web browser comprising a setting confirmation and a maximum age.

21. The user anonymous reference system of claim 20, wherein the web service is further configured to send the first call response to the user browser after receiving from the user browser an initial call, wherein the initial call comprises an origin of the user browser, and wherein the initial call is sent after the user browser accesses the web service code at the web page server.

22. The user anonymous reference system of claim 21, wherein the web service is further configured to send the second call response to the user browser after receiving a second initial call from the user browser, wherein the second initial call comprises a probe to understand permitted exchange methods.

23. The user anonymous reference system of claim 22, wherein the web service is further configured to send the third call response to the user browser after receiving a third initial call from the user browser, wherein the third initial call comprises a confirmation of one of the permitted data exchange methods.

24. The user anonymous reference system of claim 23, wherein the web service is further configured to send at least one subsequent call response to the user browser after receiving at least one subsequent call, wherein the at least one subsequent call and the at least one subsequent call response each comprise the anonymous identifier.
